(19) United States
(12) Patent Application Publication
(10) Pub. No.: US 2018/0119865 A1
(43) Pub. Date: May 3, 2018

(54) HIGH-HEAT-LOAD VACUUM DEVICE AND METHOD FOR MANUFACTURING THE SAME

(71) Applicant: NATIONAL SYNCHROTRON RADIATION RESEARCH CENTER, HSINCHU (TW)

(72) Inventors: CHE-KAI CHAN, HSINCHU (TW); CHIN SHUEH, HSINCHU (TW); CHIN-CHUN CHANG, HSINCHU (TW); LING-HUI WU, HSINCHU (TW); I CHING ALBERT SHENG, HSINCHU (TW); CHIEN-KUANG KUAN, HSINCHU (TW)

(21) Appl. No.: 15/404,769

(22) Filed: Jan. 12, 2017

Related U.S. Application Data
(60) Provisional application No. 62/417,092, filed on Nov. 3, 2016.

(51) Int. Cl. F16L 53/00; B23K 9/16; B23K 9/00; F16L 23/00

(52) U.S. Cl. CPC F16L 53/00; F16L 23/006; B23K 9/0026; B23K 9/164

(57) ABSTRACT

A high-heat-load vacuum device and method for manufacturing the same are provided. The high-heat-load vacuum device includes a high-heat-load component and a vacuum component connected to the high-heat-load component. A material of the vacuum component and a material of the high-heat-load component comprise CuCrZr alloy.

This application claims priority of U.S. provisional application Ser. No. 62/417,092 filed on Nov. 3, 2016, which is incorporated by reference in its entirety.

### TECHNICAL FIELD

The present disclosure relates to a high-heat-load vacuum device and a method for manufacturing the same, and more particularly, to a high-heat-load vacuum device formed from copper chromium zirconium (CuCrZr) alloy and a method for manufacturing the same.

### DISCUSSION OF THE BACKGROUND

An ultrahigh-vacuum (UHV) system such as a storage ring of the synchrotron radiation facility includes different components such as photon absorbers, configured to bear heat load, and vacuum flanges. configured for vacuum sealing. The absorber chamber with a photon absorber inside equips the vacuum flanges to allow the electron beams to travel in a vacuum environment. Conventionally, the photon absorber and the vacuum flange are formed from different materials and welded to each other by vacuum brazing, which is performed in a vacuum furnace in a high temperature and high vacuum environment. Thus, the cycle time is long and the manufacturing cost is high.

This Discussion of the Background section is provided for background information only. The statements in this Discussion of the Background are not an admission that the subject matter disclosed in this Discussion of the Background section constitutes prior art to the present disclosure, and no high-heat-load vacuum device and manufacturing method described in this Discussion of the Background section may be used as an admission that any high-heat-load vacuum device and manufacturing method of this application, including the high-heat-load vacuum device and manufacturing method described in this Discussion of the Background section, constitutes prior art to the present disclosure.

### SUMMARY

One aspect of the present disclosure provides a high-heat-load vacuum device formed from copper chromium zirconium (CuCrZr) alloy and a method for manufacturing the same.

A high-heat-load vacuum device according to some embodiments of the present disclosure includes a high-heat-load component and a vacuum component connected to the high-heat-load component. A material of the vacuum component and a material of the high-heat-load component comprise CuCrZr alloy.

In some embodiments, the CuCrZr alloy comprises chromium ranging from substantially 0.50% to substantially 1.50%, zirconium ranging from substantially 0.05% to substantially 0.25%, and the balance substantially all copper.

In some embodiments, the vacuum component and the high-heat-load component are formed as a monolithic structure.

In some embodiments, the vacuum component and the high-heat-load component are connected by non-vacuum welding.

In some embodiments, the vacuum component and the high-heat-load component are welded by arc welding.

In some embodiments, the vacuum component and the high-heat-load component are welded by gas tungsten arc welding (GTAW).

In some embodiments, the vacuum component comprises at least one vacuum flange, and the high-heat-load component comprises a high-heat-load absorber.

In some embodiments, the high-heat-load vacuum device further includes a vacuum passage through the vacuum component and the high-heat-load component, wherein the vacuum passage is configured to allow the electron beams to travel in a vacuum environment; and a cooling channel through the vacuum component and the high-heat-load component, wherein the cooling channel is configured to allow cooling fluid passing to bear a heat load, and the cooling channel and the vacuum passage are isolated from each other.

A method for manufacturing a high-heat-load vacuum device according to some embodiments of the present disclosure includes the following steps. A high-heat-load component and a vacuum component are provided, wherein a material of the vacuum component and a material of the high-heat-load component comprise copper chromium zirconium (CuCrZr) alloy. The high-heat-load component and the vacuum component are connected by a non-vacuum welding process.

In some embodiments, the non-vacuum welding process includes an arc welding process.

In some embodiments, the non-vacuum welding process includes a gas tungsten arc welding (GTAW) process.

In some embodiments, the vacuum component comprises at least one vacuum flange, and the high-heat-load component comprises a high-heat-load absorber.

In some embodiments, the high-heat-load vacuum device further includes a vacuum passage through the vacuum component and the high-heat-load component, wherein the vacuum passage is configured to allow electron beams to travel in a vacuum environment; and a cooling channel through the vacuum component and the high-heat-load component, wherein the cooling channel is configured to allow cooling fluid passing to bear a heat load, and the cooling channel and the vacuum passage are isolated from each other.

The high-heat-load vacuum device of the present disclosure is formed from CuCrZr alloy. The high-heat-load vacuum device is advantageous for its high yield and tensile strength, lower costs, accessibility, stainless-steel compatible weldability, machinability, high heat load sustainability and UHV compatibility.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiment disclosed may be readily utilized as a basis for modifying or designing other structures or processes for carrying out the same purposes as those of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1A is a perspective view of a high-heat-load vacuum device in accordance with some embodiments of the present disclosure;

FIG. 1B is a sectional view of a high-heat-load vacuum device in accordance with some embodiments of the present disclosure;

FIG. 2 is a schematic diagram of an outgassing system for measuring outgassing rate;

FIG. 3 shows the X-ray diffraction (XRD) pattern of CuCrZr alloy;

FIG. 4 shows the measured outgassing rate as a function of time and parameterized by temperature;

FIG. 5 shows the percentage of residual gases as a function of AMU;

FIG. 6 shows RGA signals of six major residual gases as a function of pumping time during bake-out;

FIG. 7 shows the helium leak rate as a function of fastening torque for mounting and unmounting a CuCrZr flange connected to a stainless-steel flange;

FIG. 8 shows the measured outgassing rate as a function of time and parameterized by temperature;

FIG. 9 shows leak rate of CuCrZr compared to repetition quantity of flange bolting;

FIG. 10A shows surface morphology of TiZrV getter film on CuCrZr alloy; and

FIG. 10B shows the X-ray diffraction (XRD) pattern of TiZrV getter film on CuCrZr alloy.

### DETAILED DESCRIPTION

In an ultrahigh-vacuum (UHV) system such as a storage ring of the synchrotron radiation facility, different types of high-heat-load (HHL) components have been customized to meet the various power-load and density-flux requirements of the beam-line users and to account for the thermomechanical limits of the materials. Absorber, which is a type of HHL component, is designed to be installed between straight chambers and to protect the downstream-chamber wall from irradiation by synchrotron radiation, thereby avoiding the overheating of the chamber. In addition, the pressure in UHV systems is determined mainly by the rate at which gases are desorbed from the inner wall of the chamber or from other components in the UHV system. Thus, good thermal conductivity and low thermal outgassing are among the most important characteristics of HHL components. Although copper and beryllium-copper alloy have been widely studied as materials for UHV systems, the desorption of gases from CuCrZr during baking and the stability of CuCrZr flanges for use as vacuum seals after baking have not been fully studied. Another difficulty is that oxygen-free high-conductivity (OFHC) copper and GlidCop® are commonly used for HHL components; however, a stainless-steel flange is difficult to vacuum braze with OFHC HHL body (or GlidCop®) because the structure of some HHL components (e.g., crotch absorber) with water cooling channels is complex.

To overcome this problem, the present disclosure has focused on integrating HHL components such as photon absorbers equipped with CuCrZr flanges. Thus, in some embodiments, CuCrZr alloy, which has good thermal conductivity, high softening temperature, good weldability, and high mechanical strength, is proposed as the material for both absorber and the vacuum flange. The stability of CuCrZr flanges and the desorption behavior of various gases from CuCrZr alloy are studied as a function of pumping time at a constant temperature. In some embodiments, tests of thermal outgassing and vacuum sealing are provided. For thermal outgassing, the outgassing rate and the species of desorption gases emanating from the materials during baking are measured. In order to verify the vacuum seal between the CuCrZr alloy and stainless-steel flanges, an Alcatel helium leak detector is used in some embodiments.

The following description of the disclosure accompanies drawings, which are incorporated in and constitute a high-heat-load vacuum device component of this specification, and illustrate embodiments of the disclosure, but the disclosure is not limited to the embodiments. In addition, the following embodiments can be properly integrated to complete another embodiment.

References to “one embodiment,” “an embodiment,” “exemplary embodiment,” “some embodiments,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to a high-heat-load vacuum device including a high-heat-load component and a vacuum component formed from copper chromium zirconium (CuCrZr) alloy. CuCrZr alloy has the characteristics of good thermal conductivity, high softening temperature, good weldability, high mechanical strength and low outgassing rate, and thus is able to meet different requirements for both high-heat-load components and vacuum components. The following description is also directed to a method for manufacturing a high-heat-load vacuum device, as discussed below.

In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

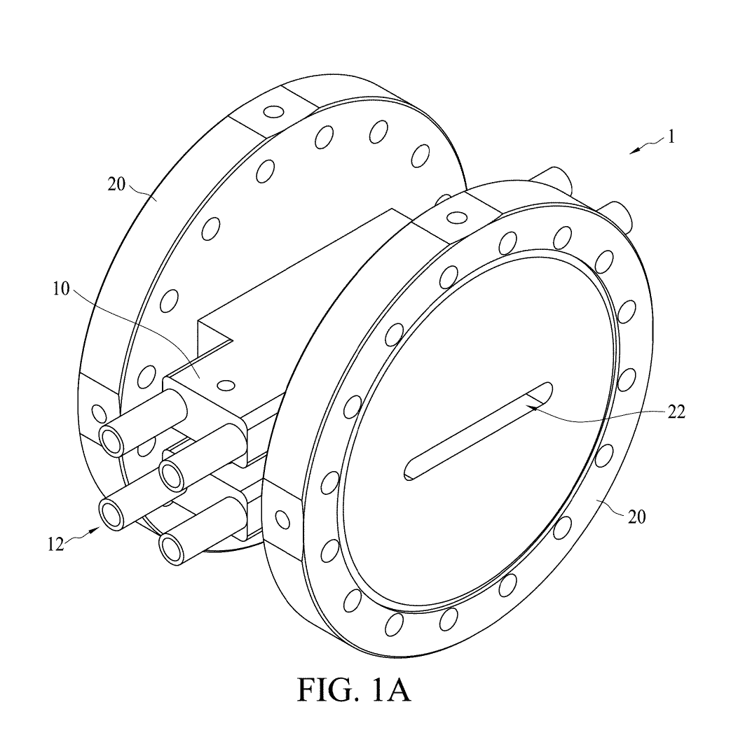

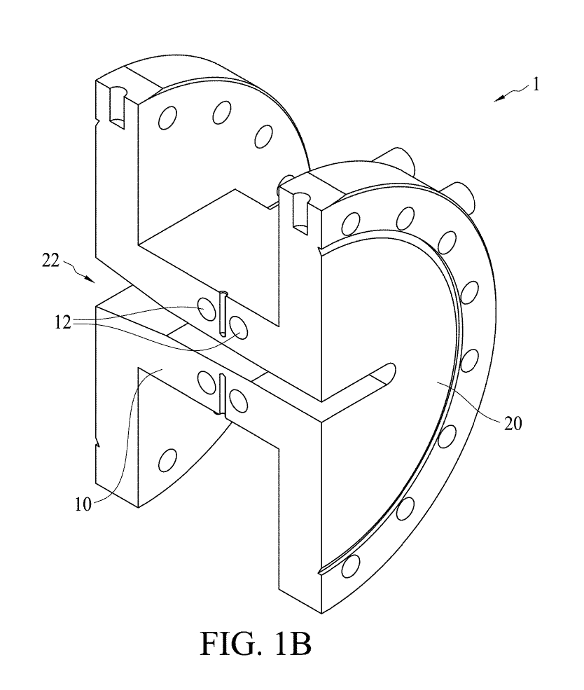

FIG. 1A is a perspective view of a high-heat-load vacuum device in accordance with some embodiments of the present disclosure. FIG. 1B is a sectional view of a high-heat-load vacuum device in accordance with some embodiments of the present disclosure. Referring to FIGS. 1A and 1B, the high-heat-load vacuum device 1 includes a high-heat-load component 10 and a vacuum component 20. In some embodiments, the high-heat-load vacuum device 1 is a device installed in an ultrahigh-vacuum (UHV) system such as a synchrotron radiation accelerator system. By way of example, the high-heat-load component 10 includes, but is not limited to, a high-heat-load absorber, and the vacuum component 20 includes, but is not limited to, a vacuum flange. The vacuum component 20 is connected to the high-heat-load component 10, for example, at an end of the high-heat-load component 10. In some embodiments, the vacuum component 20 includes two vacuum flanges connected to two ends of the high-heat-load absorber. In some embodiments, the material of the vacuum component 20 and the material of the high-heat-load component both include copper chromium zirconium (CuCrZr) alloy. In some embodiments, the high-heat-load absorber is installed in the mid-section of two or more tandem undulators to shadow miss-steered beam synchrotron radiation from an upstream EPU (elliptical polarization undulator).

In some embodiments, the high-heat-load vacuum device 1 includes one or more vacuum passages 22, and one or more cooling channels 12. In some embodiments, the vacuum passage 22 penetrates the vacuum component 20 and the high-heat-load component 10. The vacuum passage 22 is configured to allow synchrotron radiation beams to travel in a vacuum environment. In some embodiments, the vacuum passage 22 is coupled to a pump (not shown) configured to pump gas out of the vacuum passage 22 so as to provide a vacuum in the vacuum passage 22. In some embodiments, the cooling channel 12 penetrates the vacuum component 20 and the high-heat-load component 10. The cooling channel 22 is configured to allow cooling fluid to pass through in order to bear a heat load. In some embodiments, the cooling channel 12 and the vacuum passage 22 are isolated from each other.

In some embodiments, the CuCrZr alloy used for the material of the high-heat-load component 10 and the vacuum component 20 comprises chromium ranging from substantially 0.50% to substantially 1.50%, zirconium ranging from substantially 0.05% to substantially 0.25%, and the balance substantially all copper. An example of the material for the high-heat-load component 10 and the vacuum component 20 is ASTM standard C18150 alloy. The composition of the CuCrZr alloy is not limited, and may be modified to meet the requirements of thermal conductivity, softening temperature, weldability, mechanical strength, etc.

Table 1 lists material properties for OFHC, GlidCop® and CuCrZr. As shown in Table 1, CuCrZr alloy has mechanical properties comparable to those of GlidCop®, with a slightly lower thermal conductivity (16% less than that of OFHC) but higher yield and tensile strength; thus, CuCrZr alloy is a suitable material for high-heat-load and vacuum components.

TABLE 1

| Property | OFHC | GlidCop ® | CuCrZr |
|---|---|---|---|
| Conductivity | 3.83 | 3.65 | 3.23 |
| (W/cm°K) | | | |
| Thermal expansion | 16.6 | 17 | 18.6 |
| (m/°K * 10⁻⁶) | | | |
| Poisson ratio | 0.31 | 0.35 | 0.18 |
| Yield strength | 0.049-0.078 | 0.33 | 0.27-0.44 |
| (Gpa) | | | |
| Tensile strength | 0.215-0.254 | 0.42 | 0.37-0.47 |
| (Gpa) | | | |

In some embodiments, the high-heat-load component 10 and the vacuum component 20 are formed as a monolithic structure. By way of example, the high-heat-load component 10 and the vacuum component 20 made of CuCrZr alloy are machined by CNC machining from the same CuCrZr alloy material. In some alternative embodiments, the high-heat-load component 10 and the vacuum component 20 are connected by non-vacuum welding, which does not need to be performed in a vacuum furnace. By way of example, the high-heat-load component 10 and the vacuum component 20 are connected by arc welding such as gas tungsten arc welding (GTAW) (also referred to as tungsten inert gas (TIG) welding), or plasma arc welding (PAW).

In some embodiments, the vacuum component 20 made of CuCrZr alloy is connected to a different part of the high-heat-load vacuum device 1 through a stainless steel vacuum flange (not shown), for example with bolts. In some embodiments, the CuCrZr flange and the stainless-steel flange are connected with a gasket such as an oxygen-free copper gasket formed therebetween to improve vacuum sealing effect.

Experiment 1

1. Material

To increase the accuracy of the measurement, 22 sheets (0.85 cm×10.06 cm×7.04 cm for each sheet) of the CuCrZr alloy (ASTM C18150) with a total surface area of about 3927 cm² were formed by computer numeric control (CNC) machining CuCrZr alloys have thermal conductivity of 324 W m⁻¹K, a softening temperature of 500° C., and coefficient of thermal expansion of 16.7×10⁻⁶K⁻¹. The hardness of CuCrZr alloys is approximately 150 to 160 in HV.

2. Throughput Method

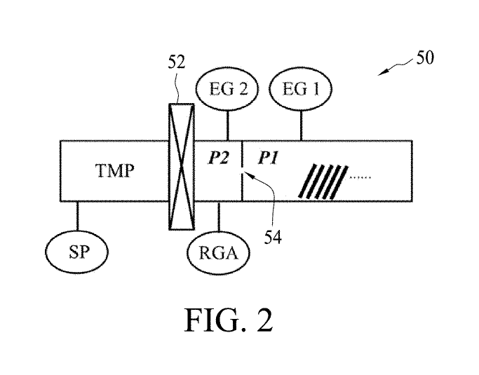

Before measuring the outgassing rate, each sample was cleaned by Citranox cleaning, which includes ultrasonic cleaning in Citranox detergent (2% by volume) at 60° C. and deionized water for 10 minutes each and drying with pure dinitrogen (99.9999%). FIG. 2 is a schematic diagram of an outgassing system for measuring outgassing rate. Referring to FIG. 2, the outgassing system 50 includes a turbo molecular pump TMP (e.g., STP-301), a sorption pump SP, a sample chamber P1, a pumping chamber P2, two extractor gauges EG1 and EG2 configured to measure the pressure in the sample chamber P1 and the pumping chamber P2, a residual-gas analyzer RGA configured to determine the species of desorbed gases, and a gate valve 52 between the TMP and the pumping chamber P2. An orifice 54 with 3 mm diameter is between the sample chamber P1 and the pumping chamber P2, and the orifice conductance is 0.814 L/s at ambient temperature.

The outgassing rate was measured using a throughput method in real time. The throughput method is based on the following equations:

Q=C(P_{P1}−P_{P2}) (1)

q=Q/A (2)

where Q is the total outgassing rate (Pa m³/s), q is the outgassing rate per unit area (Pa m/s), C is the orifice conductance, P_{P1} is the pressure in the sample chamber P1, P_{P2} is the pressure in the pumping chamber P2, and A is the sample area.

First, the outgassing rate Q_{SS} of the empty sample chamber P1 is measured. Next, the CuCrZr alloy is put into the sample chamber P1 and the resulting outgassing rate Q_{SS+CuCrZr} is decremented by Q_{SS} to obtain the outgassing rate Q_{CuCrZr} of CuCrZr alloy. All measurements of the outgassing rate are performed during the following baking process: (i) pump down for 22 hours; (ii) heat sample chamber at 0.6° C./min to 160° C. and maintain this temperature for 20 hours; (iii) cool to room temperature at 0.25° C./min. To verify the vacuum seal, the CuCrZr flanges are mounted to and unmounted from stainless-steel flanges for ten cycles, followed by bake-out at 250° C., to make sure that the CuCrZr flanges are suitable for use in a UHV system.

3. Results and Discussion

Outgassing Rate

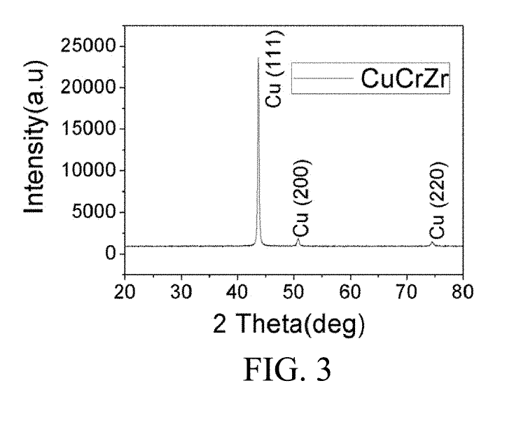

FIG. 3 shows the X-ray diffraction (XRD) pattern of CuCrZr alloy. Referring to FIG. 3, an fcc Cu(111) structure with a 0.36 nm lattice constant is shown. In addition, the Cu(111) fraction is 87%, followed by Cu(200) with 7%, and Cu(220) with 6%. The Scherrer equation gives a mean grain size of CuCrZr of 26 nm. Thus, CuCrZr(111) is the dominant morphology.

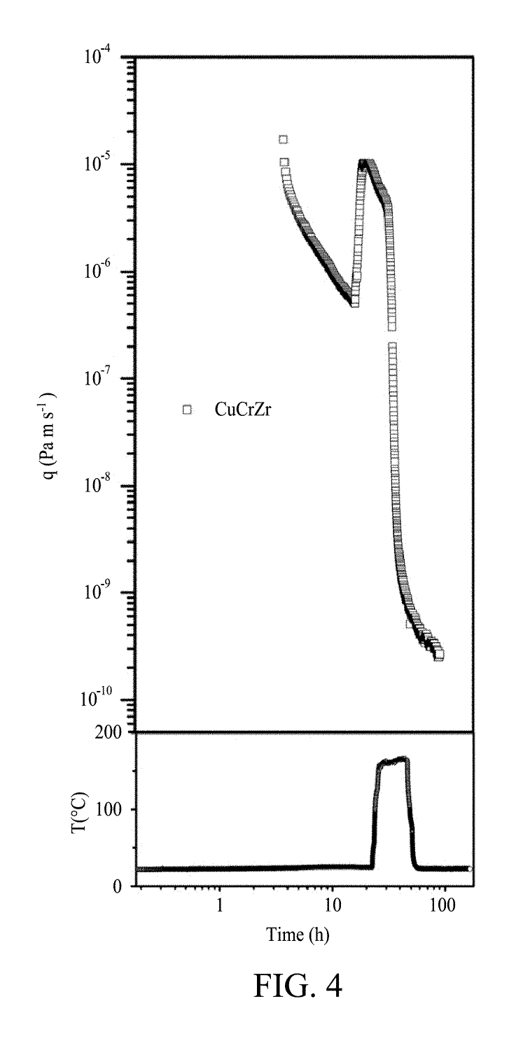

FIG. 4 shows the measured outgassing rate as a function of time and parameterized by temperature. Referring to FIG. 4, the outgassing rates at 10 hours and 72 hours (q10 and q72) are given in Table 2 and compared with those for aluminum (Al) and stainless steel. The outgassing rate decreases with time, then increases once bake-out (160° C.) starts. After 10 hours of pumping, the outgassing of CuCrZr, Al, and stainless steel is 1.2×10⁻⁶, 3.3×10⁻⁷, and 1.8×10⁻⁷ Pa m/s, respectively. The outgassing of Al and stainless steel is about an order of magnitude less than that of CuCrZr. However, these rates become roughly the same (10⁻¹⁰ Pa m/s) after 72 hours of pumping. The slightly high initial outgassing rate of CuCrZr may be because the main source of outgassing is near the surface, making it easily desorbed by baking and giving the large rate q10.

TABLE 2
Outgassing rate (Pa m/s)

Pumping time

| | 10 hours | 72 hours |
|---|---|---|
| CuCrZr | 1.2 × 10⁻⁶ | 5.8 × 10⁻¹⁰ |
| Al | 3.3 × 10⁻⁷ | 1.6 × 10⁻¹⁰ |
| Stainless steel | 1.8 × 10⁻⁷ | 1.5 × 10⁻¹⁰ |

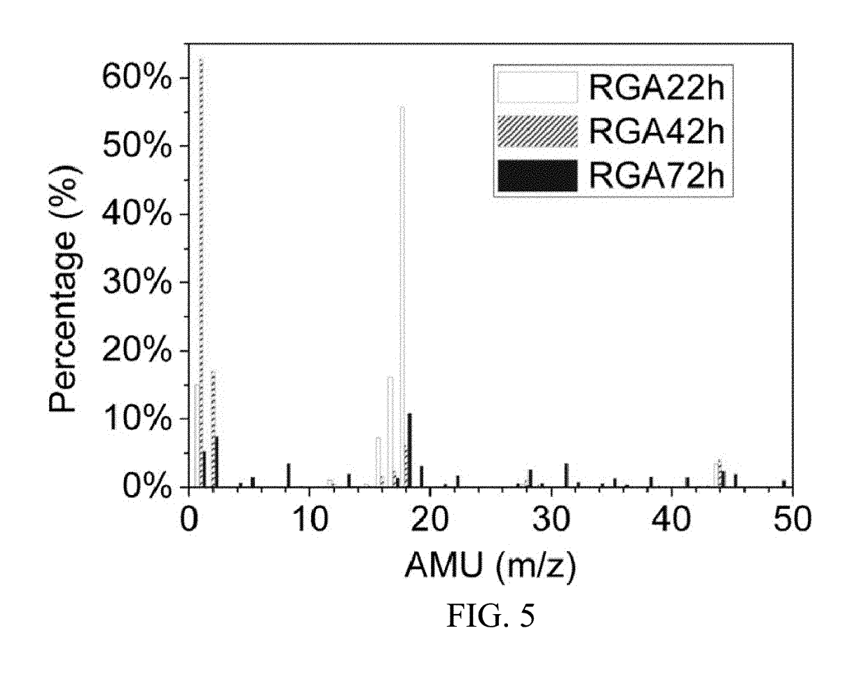

FIG. 5 shows the percentage of residual gases after 22 hours, 42 hours, and 72 hours, which correspond to unbaked, baking at 160° C., and after baking, respectively. Before baking (RGA22), H₂O (mass-to-charge ratio (m/z)˜18) is the dominant residual gas from CuCrZr alloy. After pumping for 42 hours, the main desorbed gases are H⁺ and H₂⁺ (m/z˜1.2); at this point thermal energy removes the sorbed H₂O from the surface during bake-out at 160° C. After pumping for 72 hours, the residual gases H⁺, H₂⁺, CH₄⁺, H₂O⁺, CO⁺, O2⁺, and CO2⁺ are detected, with ratios m/z corresponding to 1, 2, 16, 18, 28, 32 and 44 amu.

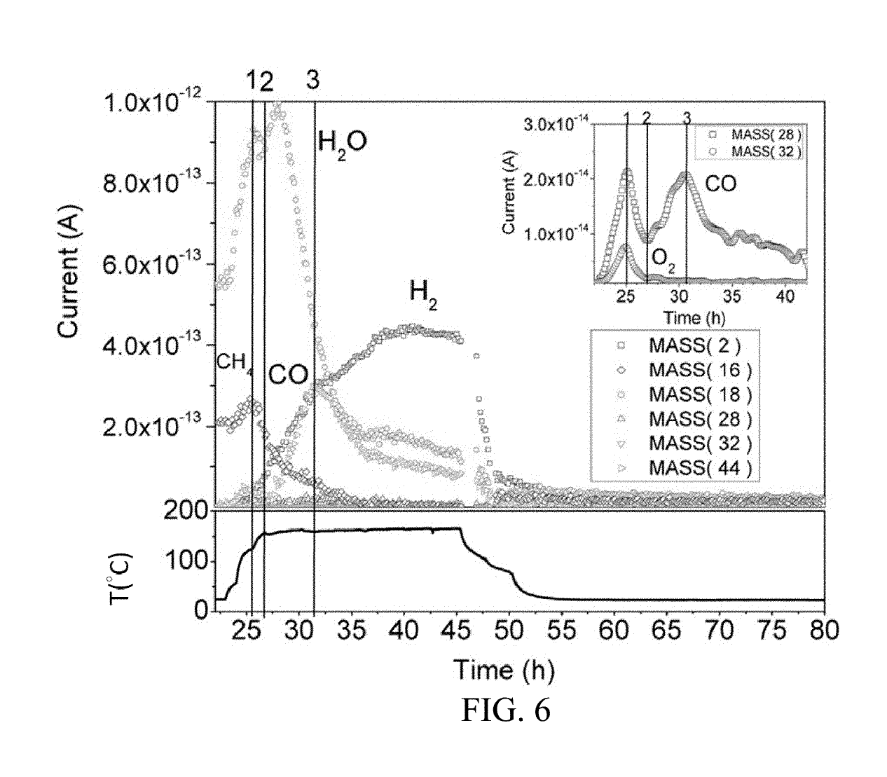

FIG. 6 shows RGA signals of six major residual gases as a function of pumping time during bake-out at 160° C. The inset shows a magnified scale of the RGA signals of O₂ and CO residual gases. To understand why the desorption rate increases during bake-out at 160° C., consider the RGA signal during bake-out (FIG. 6). The results focus on H₂, CH₄, H₂O, CO, O₂, and CO₂, with m/z corresponding to 2, 16, 18, 28, 32, and 44 amu, respectively. H₂O exhibits a strong signal at the onset of baking. During stage one (25.5 hours; 110 to 130° C.; see stages indicated in FIG. 6), desorption peaks appear for H₂, CH₄, H₂O, 0₂, CO, and CO₂. H₂O is attributed to residual water on the CuCrZr surface remaining from the deionized water used for cleaning and from the ambient environment. The other gases are attributed to residual copper hydroxide and copper carbonate on the surface from manufacturing. In stage two (27 to 32 hours; 160° C.), the signals for CO₂, H₂O, and CO increase again, which implies that gases from the CuCrZr surface or from bulk desorption dominate; however, the H₂O signal drops dramatically after 30 minutes. In stage three (>32 hours), the signals for CO₂ and CO decrease simultaneously. However, the H₂⁺ signal has a broad peak that reflects the baking temperature. The main source of hydrogen in CuCrZr bulk is from the casting process; these results agree with those of Watanabe, et al. (F. Watanabe, Mechanism of ultralow outgassing rates in pure copper and chromium-copper alloy vacuum chambers: reexamination by the pressure-rise method, J. Vac. Sci. Technol. A 19 (2) (2001) 640-645), who observed an enhanced hydrogen concentration in an isolated vacuum system even after bake-out at 250° C. Finally, strong H₂O and CO₂ signals appear during the initial 10 hours of bake-out at 160° C., which implies that, after bake-out at 160° C. for 10 hours, two sources of desorption gases appear: one from the material bulk and one from the weak decomposition of copper hydroxide and copper carbonate at the surface [CuCO₃.CO(OH)₂→2CuO+CO₂+H₂O] as disclosed by Watanabe, et al. ((F. Watanabe, Mechanism of ultralow outgassing rates in pure copper and chromium-copper alloy vacuum chambers: reexamination by the pressure-rise method, J. Vac. Sci. Technol. A 19 (2) (2001) 640-645) and (F. Watanabe, M. Suemitsu, N. Miyamoto, In situ deoxidization/oxidization of a copper surface: a new concept for attaining ultralow outgassing rates from a vacuum wall, J. Vac. Sci. Technol. A 13 (1) (1995) 147-150). In addition, before stage three (<32 hours), the RGA signals give H₂O>H₂>O₂, in agreement with the results of Jiang, et al. (Z. Jiang, T. Fang, Dissociation mechanism of H₂O on clean and oxygen-covered Cu (111) surfaces: a theoretical study, Vacuum (2016)), who calculated adsorption energies of H₂O, H, and O on a Cu(111) surface of 0.28, 2.57, and 4.28 eV, respectively. Lower adsorption energy implies that the gas is easier to desorb from the surface. These results indicate that the main source of the desorption gases was from the surface before stage three (baking time ˜6.5 hours). These results indicate that residual gas from CuCrZr alloy can be removed by bake-out at 160° C. for over 10 hours.

Vacuum Sealing Test

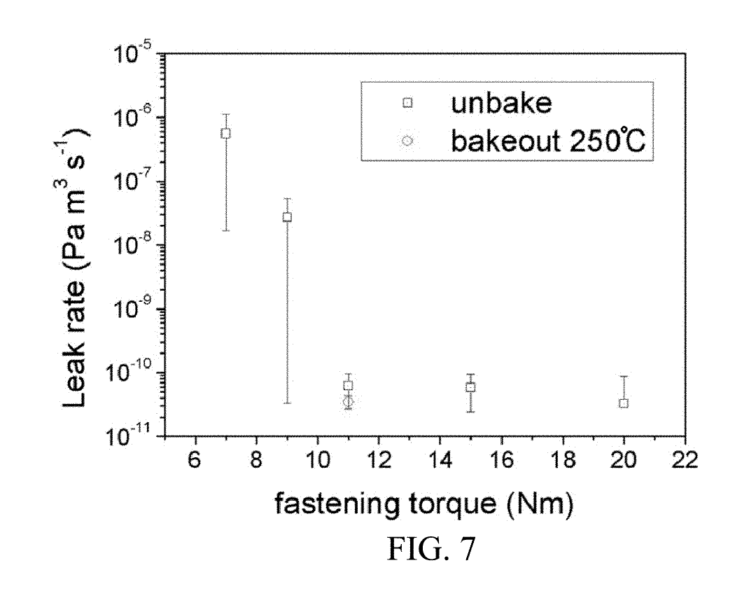

FIG. 7 shows the helium leak rate as a function of fastening torque (7, 9, 11, 15, and 20 N m) for mounting and unmounting a CuCrZr flange connected to a stainless-steel flange ten times with stainless-steel M8 bolts. The CuCrZr (ASTM C18150) and stainless-steel flanges were of the DN 100 ConFlat® type formed by CNC machining, which is the same size and machining method as an absorber flange. The results reveal that a fastening torque ≥11 N m is required to achieve a good vacuum seal (i.e., a leak rate below 9.6×10⁻¹¹ Pa m³/s and no helium leak signal after injecting helium between the CuCrZr and stainless-steel flanges).

The thermal expansion coefficient of CuCrZr differs from that of stainless steel, so leaks may arise due to thermal cycling (e.g., when an absorber is heated by irradiation). To verify that the seal could tolerate thermal cycling, the CuCrZr and stainless-steel flanges were mounted and unmounted ten times with a torque of 11 N m (see FIG. 7) between bake-out at 250° C. for 24 hours. Although the CuCrZr flange was severely oxidized on the air side after bake-out at 250° C., no vacuum leak was detected. The leak rate of the CuCrZr and stainless-steel flanges was 2.6×10⁻¹¹-4.3×10⁻¹¹ Pa m³/s.

The hardness of CuCrZr is slightly less than that of stainless steel, which means that the knife edge of the CuCrZr flange is preferably carefully connected with the stainless-steel flange with an oxygen-free copper gasket.

Experiment 2

1. Material

The CuCrZr alloy plates have a total surface area of 4000 cm² in the vacuum chamber. The CuCrZr alloy plates were ultrasonically cleaned in Citranox®, rinsed with de-ionized water for 10 minutes, and dried with 99.9999% nitrogen.

2. Results and Discussion

Outgassing Rate

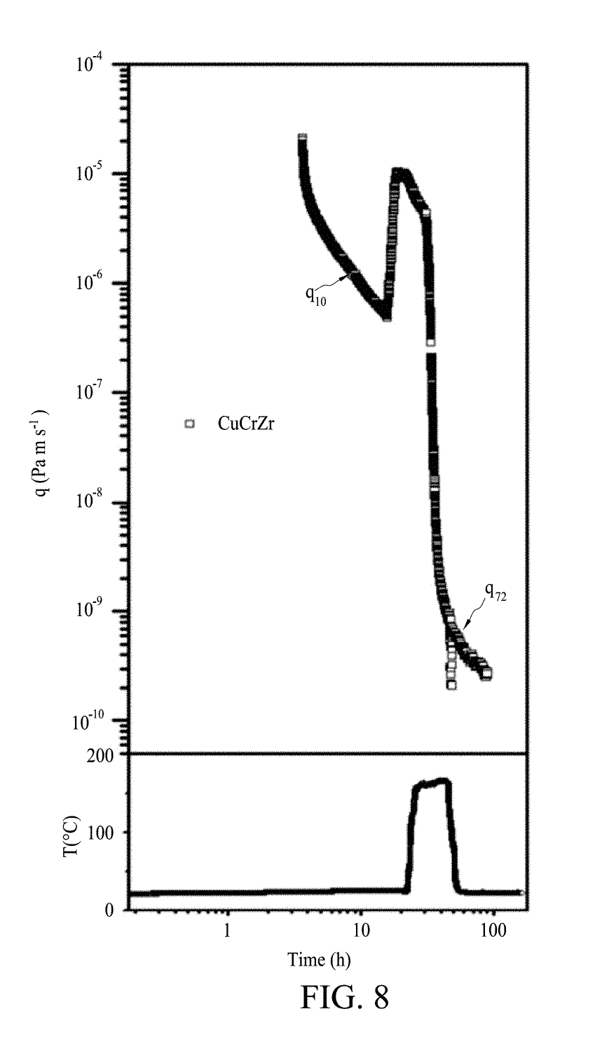

FIG. 8 shows the measured outgassing rate as a function of time and parameterized by temperature. Referring to FIG. 8, the outgassing rates at 10 hours and 72 hours (q10 and q72) are given in Table 3 and compared with those for aluminum (Al) and stainless steel.

TABLE 3
Outgassing rate (Pa m/s)

Pumping time

| | 10 hours | 72 hours |
|---|---|---|
| CuCrZr | 1.6 × 10⁻⁶ | 5.8 × 10⁻⁶ |
| Al | 3.3 × 10⁻⁶ | 1.6 × 10⁻⁶ |
| Stainless steel | 1.8 × 10⁻⁶ | 1.5 × 10⁻⁶ |

Vacuum Sealing Test

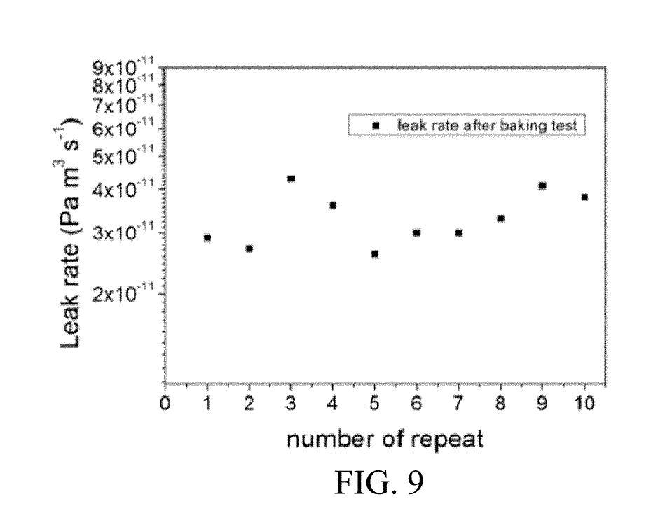

FIG. 9 shows leak rate of CuCrZr after multiple repetitions of flange bolting. A series of bake-out tests is also performed. 11 N m of torque is applied while bolting the CuCrZr flange to a stainless steel flange. The object was then baked, pumped down, a new copper gasket installed, and the flange was then bolted again. A total of 10 cycles of this process was repeated with the same CuCrZr flange. Each time its leak rate was recorded. FIG. 9 illustrates that even after 10 bake-out cycles, the CuCrZr flange still has good leak rate. No visual damage to the knife edges was observed.

NEG Coating

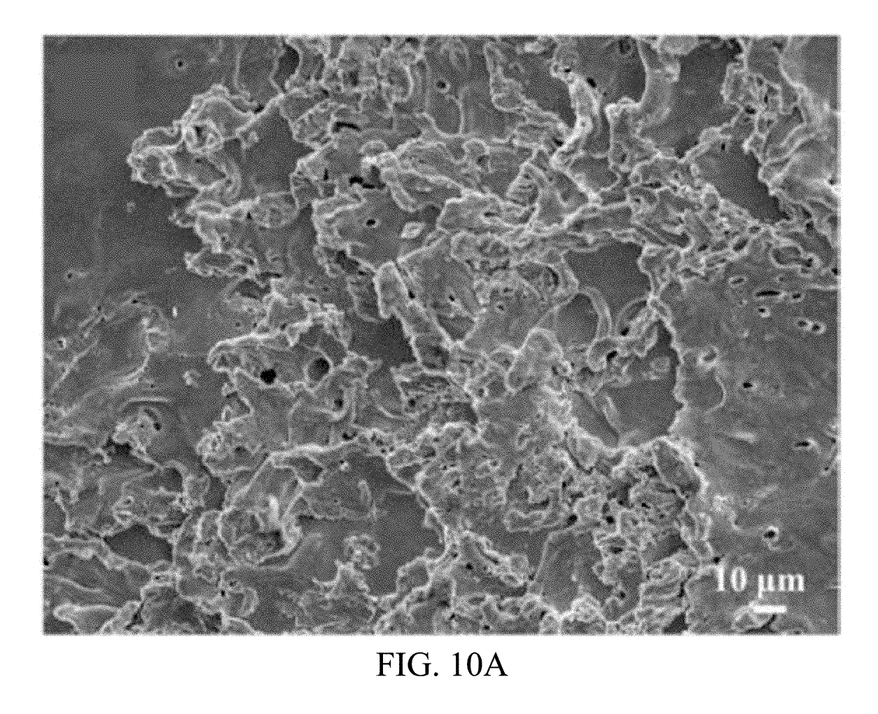

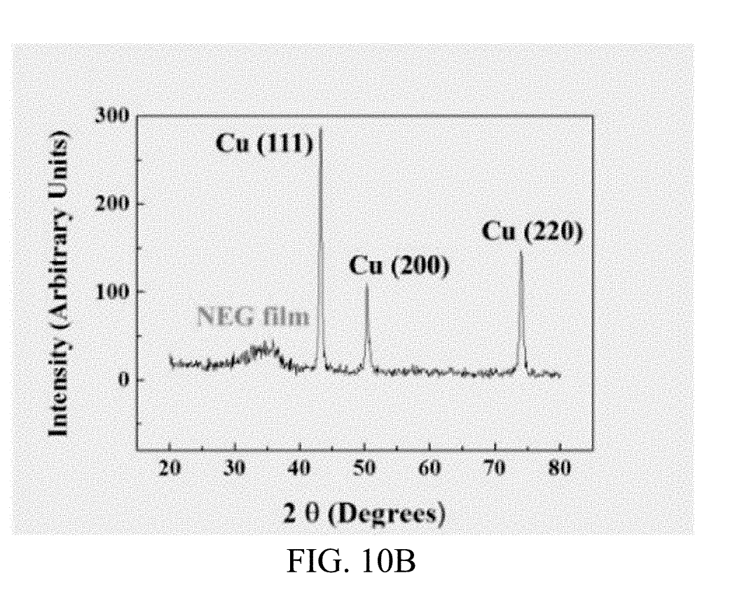

In some embodiments, an NEG (non-evaporable getter) coating is applied over the CuCrZr material. The NEG coating such as a titanium zirconium vanadium (TiZrV) getter film is grown on the CuCrZr alloys. Prior to the deposition of the getter film, the CuCrZr samples are cleaned by the same standard cleaning process as performed on the vacuum chambers. In some embodiments, a direct current sputtering method is used. The base pressure of the sputtering chamber is 1.5×10⁻⁴ Pa. The thickness of the films is in the range of about 0.5-1 um. After a getter film coating is completed, the samples are subjected to a series of analyses and measurement. The surface morphology and the X-ray diffraction pattern of the film are shown in FIGS. 10A and 10B, respectively. The NEG films have a rough surface and circular pores. In addition, the signals indicated in FIG. 10B come from the TiZrV getter films and the original substrate. The peak associated with the TiZrV film occurs at approximately 2θ=34°. The average grain size of TiZrV films is calculated to be approximately 1.5 nm. This indicates that the TiZrV films have nanocrystalline structures.

Some embodiments of the present disclosure provide a high-heat-load vacuum device formed from CuCrZr alloy. The high-heat-load vacuum device is advantageous for its high yield and tensile strength, lower cost, accessibility, stainless-steel compatible weldability, machinability, high heat load sustainability, and UHV compatibility.

Some embodiments of the present disclosure provide a method for manufacturing a high-heat-load vacuum device. The method includes connecting a high-heat-load component and a vacuum component by a non-vacuum welding process to form a high-heat-load vacuum device. The non-vacuum welding process, compared to a vacuum welding process such as vacuum brazing, is more economical and efficient.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A high-heat-load vacuum device, comprising:
a high-heat-load component; and
a vacuum component connected to the high-heat-load component, wherein a material of the vacuum component and a material of the high-heat-load component comprise copper chromium zirconium (CuCrZr) alloy.

2. The high-heat-load vacuum device of claim 1, wherein the CuCrZr alloy comprises chromium ranging from substantially 0.50% to substantially 1.50%, zirconium ranging from substantially 0.05% to substantially 0.25%, and the balance substantially all copper.

3. The high-heat-load vacuum device of claim 1, wherein the vacuum component and the high-heat-load component are formed as a monolithic structure.

4. The high-heat-load vacuum device of claim 1, wherein the vacuum component and the high-heat-load component are connected by non-vacuum welding.

5. The high-heat-load vacuum device of claim 4, wherein the vacuum component and the high-heat-load component are welded by arc welding.

6. The high-heat-load vacuum device of claim 5, wherein the vacuum component and the high-heat-load component are welded by gas tungsten arc welding (GTAW).

7. The high-heat-load vacuum device of claim 1, wherein the vacuum component comprises at least one vacuum flange, and the high-heat-load component comprises a high-heat-load absorber.

8. The high-heat-load vacuum device of claim 7, further comprising:
a vacuum passage through the vacuum component and the high-heat-load component, wherein the vacuum passage is configured to allow electron beams to travel in a vacuum environment; and
a cooling channel through the vacuum component and the high-heat-load component, wherein the cooling channel is configured to allow cooling fluid to pass through in order to bear a heat load, and the cooling channel and the vacuum passage are isolated from each other.

9. A method for manufacturing a high-heat-load vacuum device, comprising:
providing a high-heat-load component and a vacuum component, wherein a material of the vacuum component and a material of the high-heat-load component comprise copper chromium zirconium (CuCrZr) alloy; and
connecting the high-heat-load component and the vacuum component by a non-vacuum welding process.

10. The method of claim 9, wherein the non-vacuum welding process comprises an arc welding process.

11. The method of claim 10, wherein the non-vacuum welding process comprises a gas tungsten arc welding (GTAW) process.

12. The method of claim 9, wherein the vacuum component comprises at least one vacuum flange, and the high-heat-load component comprises a high-heat-load absorber.

13. The method of claim 12, wherein the high-heat-load vacuum device further comprises:
a vacuum passage through the vacuum flange and the high-heat-load absorber, wherein the vacuum passage is configured to allow electron beams to travel in a vacuum environment; and
a cooling channel through the vacuum flange and the high-heat-load absorber, wherein the cooling channel is configured to allow cooling fluid to pass through in order to bear a heat load, and the cooling channel and the vacuum passage are isolated from each other.
